(19) United States
(12) Patent Application Publication
(10) Pub. No.: US 2017/0328653 A1
(43) Pub. Date: Nov. 16, 2017

(54) FLOW DISTRIBUTOR FOR TWO-PHASE FLOW

(71) Applicant: Hamilton Sundstrand Corporation, Charlotte, NC (US)

(72) Inventors: James R. O'Coin, Somers, CT (US); Jeremy M. Strange, Windsor, CT (US)

(21) Appl. No.: 15/151,551

(22) Filed: May 11, 2016

(51) Int. Cl. F28F 9/02; F25B 39/00; F28D 1/053; B01F 5/06; F25B 39/02

(52) U.S. Cl. CPC F28F 9/0275; F28D 1/05316; B01F 5/0652; F25B 39/00; F25B 39/028

(57) ABSTRACT

A fluid distributor for a two-phase fluid flow system includes a distributor housing, a distributor inlet at the distributor housing to admit a two-phase fluid flow to the fluid distributor, a nozzle section through which the two-phase fluid flow is directed, a plurality of flow distribution passages located downstream of the nozzle section, and a plurality of passage outlets in the distributor housing. Each passage outlet of the plurality of passage outlets is coupled to one or more flow distribution passages. The plurality of flow distribution passages are configured and arrayed such that the two-phase flow through the plurality of passage outlets is uniform.

### BACKGROUND

The subject matter disclosed herein relates to fluid flow systems. More particularly, the present disclosure relates to distribution of two-phase flow in fluid flow systems.

Non-uniform flow of the two-phase flow through the heat exchanger has a negative effect on the heat exchanger performance. Two phase flow, however, is inherently non-uniform, and achieving uniform two-phase flow to and through the many channels of a heat exchanger is typically very difficult. This is especially difficult when the heat exchanger channels are stacked vertically, and under the influence of gravity, the liquid phase has a tendency to proceed to the lowermost channels, with the gas phase collecting in the uppermost layers. Without uniform distribution of the two-phase flow, the system performance is reduced, which leads to increases in system size and complexity to achieve the desired performance. The increase in size increases system weight and cost.

### SUMMARY

In one embodiment, a fluid distributor for a two-phase fluid flow system includes a distributor housing, a distributor inlet at the distributor housing to admit a two-phase fluid flow to the fluid distributor, a nozzle section through which the two-phase fluid flow is directed, a plurality of flow distribution passages located downstream of the nozzle section, and a plurality of passage outlets in the distributor housing. Each passage outlet of the plurality of passage outlets is coupled to one or more flow distribution passages. The plurality of flow distribution passages are configured and arrayed such that the two-phase flow through the plurality of passage outlets is uniform.

Additionally or alternatively, in this or other embodiments a passage inlet surface is located downstream of the nozzle section. Each flow distribution passage has a passage inlet at the passage inlet surface.

Additionally or alternatively, in this or other embodiments a plurality of passage inlets are dispersed across the passage inlet surface.

Additionally or alternatively, in this or other embodiments a plurality of plenums are located in the housing. Each plenum is coupled to a passage outlet and at least one flow distribution passage.

Additionally or alternatively, in this or other embodiments two or more flow distribution passages are coupled to the same plenum of the plurality of plenums.

Additionally or alternatively, in this or other embodiments each flow distribution passage is coupled to only one passage outlet of the plurality of passage outlets.

Additionally or alternatively, in this or other embodiments the nozzle section includes a converging portion, a throat portion downstream of the converging portion and a diverging portion downstream of the throat portion.

Additionally or alternatively, in this or other embodiments the fluid distributor is formed via one or more additive manufacturing processes.

In another embodiment, a two-phase fluid flow heat exchanger includes a plurality of heat exchange passages and a fluid distributor operably connected to the plurality of heat exchange passages. The distributor includes a distributor housing, a distributor inlet at the distributor housing to admit a two-phase fluid flow to the fluid distributor, a nozzle section through which the two-phase fluid flow is directed, a plurality of flow distribution passages located downstream of the nozzle section, and a plurality of passage outlets in the distributor housing. Each passage outlet of the plurality of passage outlets is coupled to one or more flow distribution passages and to a heat exchange passage of the plurality of heat exchange passages. The plurality of flow distribution passages are configured and arrayed such that the two-phase flow through the each of the heat exchange passages is uniform.

Additionally or alternatively, in this or other embodiments a passage inlet surface is located downstream of the nozzle section. Each flow distribution passage has a passage inlet at the passage inlet surface.

Additionally or alternatively, in this or other embodiments a plurality of passage inlets are dispersed across the passage inlet surface.

Additionally or alternatively, in this or other embodiments a plurality of plenums are located in the housing. Each plenum is coupled to a passage outlet and at least one flow distribution passage.

Additionally or alternatively, in this or other embodiments two or more flow distribution passages are coupled to the same plenum of the plurality of plenums.

Additionally or alternatively, in this or other embodiments each flow distribution passage is coupled to only one passage outlet of the plurality of passage outlets.

Additionally or alternatively, in this or other embodiments the nozzle section includes a converging portion, a throat portion downstream of the converging portion and a diverging portion downstream of the throat portion.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of a heat exchanger system including an embodiment of a flow distributor;

FIG. 2 is a cross-sectional view of an embodiment of a flow distributor;

FIG. 3 is a cross-sectional view illustrating an exemplary array of flow distribution passage inlets for an embodiment of a flow distributor; and

FIGS. 4-10 illustrate exemplary cross-sectional views of an embodiment of a flow distributor.

### DETAILED DESCRIPTION

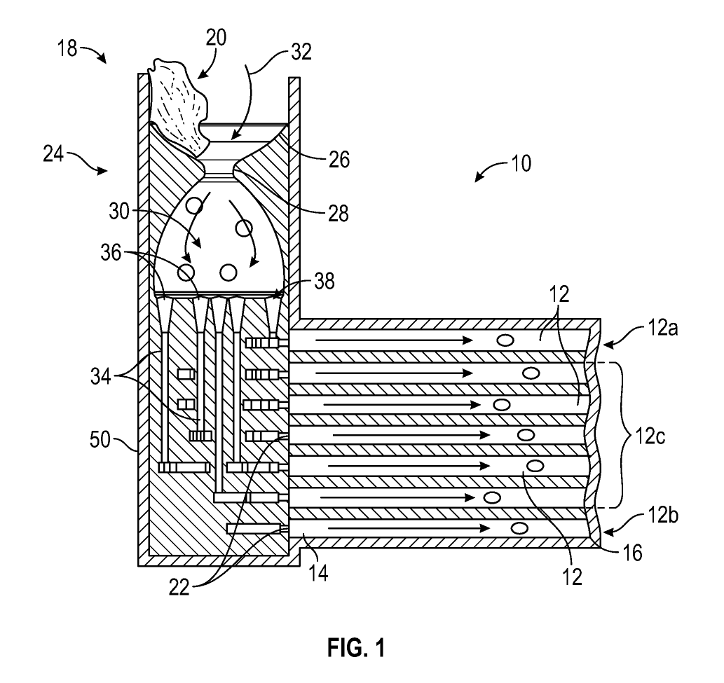

Referring now to FIG. 1, illustrated is a partial cross-sectional view of a portion of a fluid flow system, for example, a heat exchanger 10. The heat exchanger 10 includes a plurality of flow passages 12, through which a two-phase flow of, for example, a refrigerant, coolant or other fluid is directed. In the embodiment shown in FIG. 1, the flow passages 12 are arranged in a vertical stack, with each flow passage 12 having a passage inlet 14 and a passage outlet 16. Each flow passage 12 extends substantially horizontally between its respective passage inlet 14 and passage outlet 16. A flow distributor 18 is connected to the flow passages 12 at each passage inlet 14 and extends vertically from an uppermost flow passage 12a to lowermost flow passage 12b, across one or more intermediate flow passages 12c. It is to be appreciated that the arrangement shown in FIG. 1 is merely exemplary, and that heat exchanger 10 is only one example of a type of fluid flow system in which the flow distributor 18 of the present disclosure may be utilized. Further, the arrangement of components shown in FIG. 1 and described herein is merely exemplary. For example, in some embodiments, the flow passages 12 may extend vertically between their respective passage inlet 14 and passage outlet 16, with the flow distributor 18 extending horizontally across the plurality of flow passages 12.

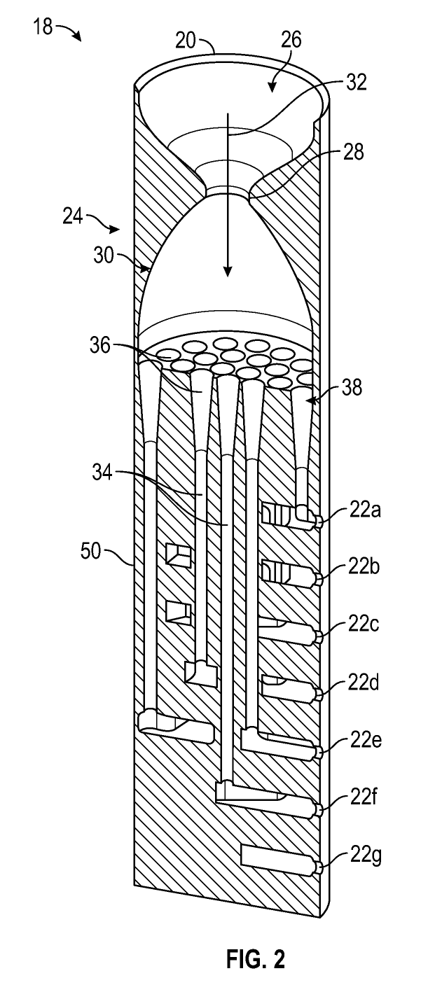

Referring now to FIG. 2, a cross-sectional view of an embodiment of the flow distributor 18 is illustrated. The flow distributor 18 has a housing 50, with a flow inlet 20 located at the housing 50, in this embodiment, at an upper extent of the flow distributor 18. The flow distributor 18 also includes a plurality of flow outlets 22, each flow outlet 22 connectable to a corresponding passage inlet 14 (shown in FIG. 1) of the heat exchanger 10. Proceeding from the flow inlet 20, in this embodiment downwardly from the flow inlet 20, the flow distributor 18 includes a nozzle section 24. The nozzle section 24 includes a converging portion 26, a throat portion 28 and a diverging portion 30 downstream of the throat portion 28, relative to a direction of fluid flow 32 into the flow distributor 18. The nozzle section 24 acts to accelerate the fluid flow 32 and break up a liquid portion of the two-phase fluid flow 32 into droplets of reduced size by the increased velocity of the gaseous portion of the two-phase fluid flow 32. Utilization of the nozzle section 24 to reduce the droplet size of the liquid portion of the fluid flow 32, allows for more uniformity and homogeneity of the two-phase fluid flow 32.

Downstream of the diverging portion 30, the flow distributor 18 includes a plurality of flow distribution passages 34 that each direct a portion of the fluid flow 32 to a flow outlet 22 of the plurality of flow outlets 22. Each flow distribution passage 34 has a distribution passage inlet 36 located at an inlet surface 38 downstream of the diverging portion 30. The flow distribution passages 34 are configured and arrayed to deliver a uniform two phase fluid flow 32 to each flow outlet 22, so that flow through the flow passages 12 is uniform. Uniformity may include an amount of liquid portion and gaseous portion in the two phase fluid flow 32, and may also refer to substantially equal flow rates and/or pressures of the fluid flow 32 through each of the flow passages 12.

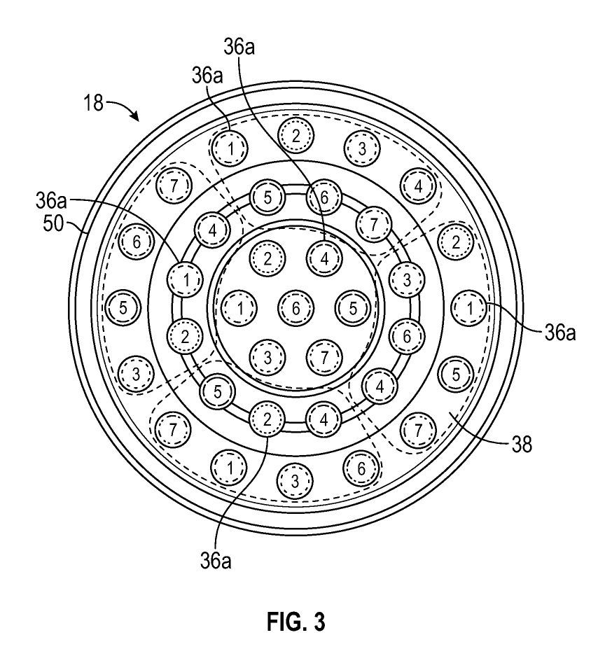

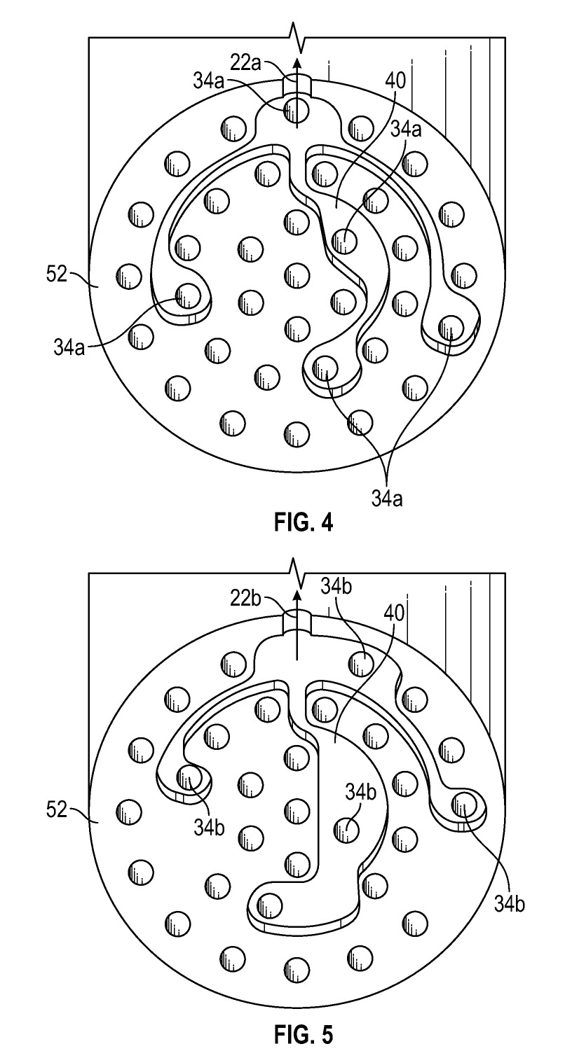

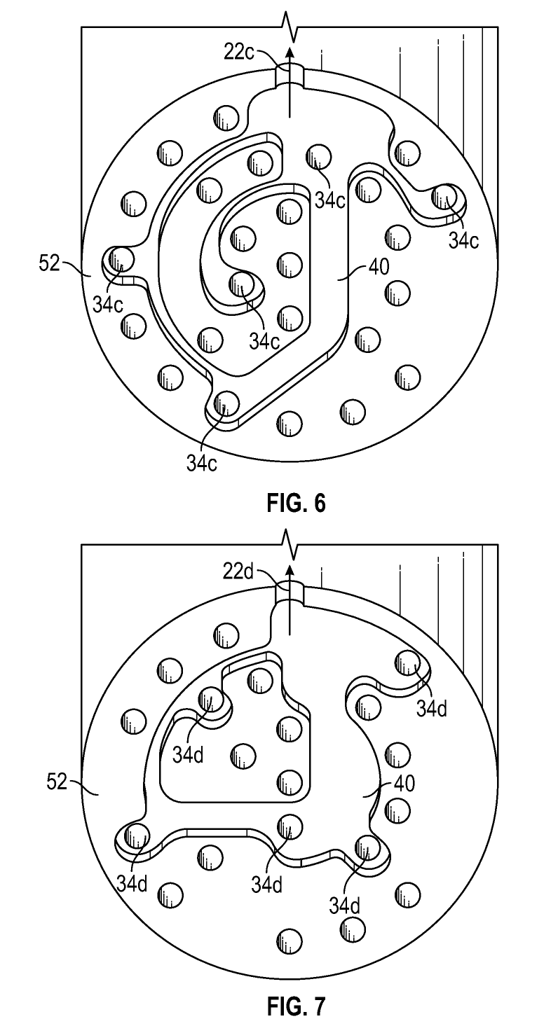

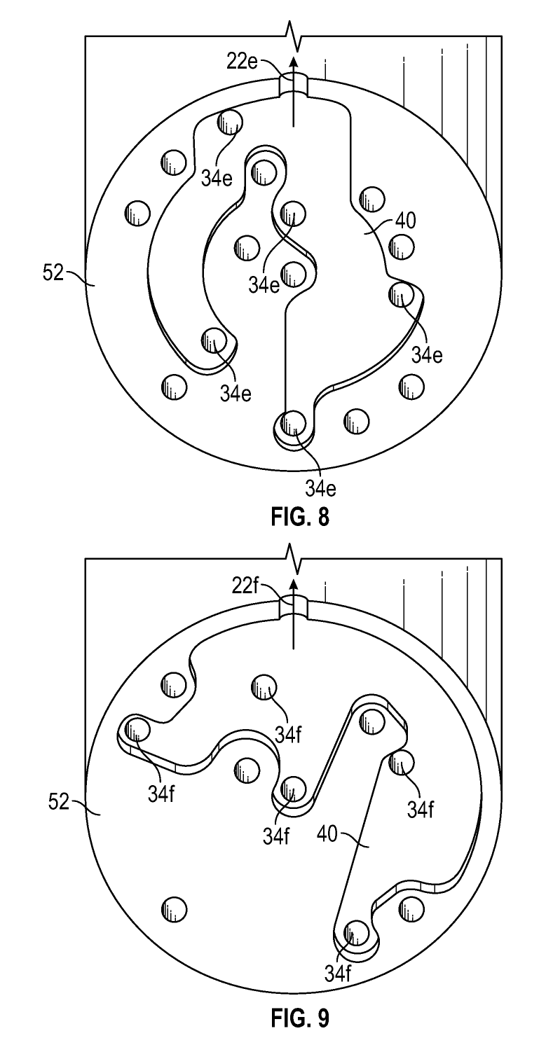

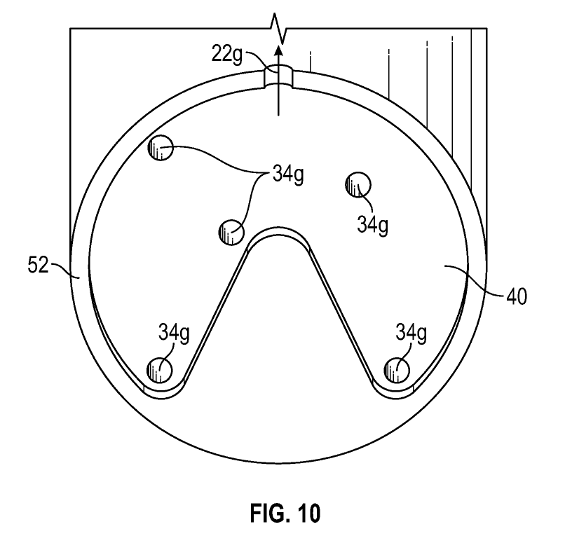

To achieve this, referring now to FIG. 3, the distribution passage inlets 36 have a random distribution at the inlet surface 38. For example, referring again to FIG. 1, an embodiment of flow distributor 18 has seven flow outlets 22, each connected to and feeding one of seven flow passages 14. Referring again to FIG. 3, the embodiment includes 35 distribution passage inlets 36, with five distribution passage inlets 36 coupled to each of the seven flow outlets 22. As shown in FIG. 3, the arrangement of the distribution passage inlets 36, relative to their connection to a particular flow outlet 22 is dispersed across the inlet surface 38, in an effort to improve the uniformity of the fluid flow 32 in the flow passages 12 relative to each other. In the embodiment of FIG. 3, distribution passage inlets 36a, for example, are coupled to flow outlet 22a. While shown better in FIGS. 4-10, distribution passages 34b are coupled to flow outlet 22b, distribution passages 34c are coupled to flow outlet 22c, distribution passages 34d are coupled to flow outlet 22d, distribution passages 34e are coupled to flow outlet 22e, distribution passages 34f are coupled to flow outlet 22f, and distribution passages 34g are coupled to flow outlet 22g, via their respective distribution passage inlets 36 located at inlet surface 38.

While in the embodiment of FIG. 3, the distribution passage inlets 36 are arrayed in a circular pattern with a distribution passage inlet 36 located at a center of the inlet surface 38, other patterns are contemplated within the scope of the present disclosure. For example, in some embodiments the center distribution passage inlet 36 may be omitted, while in other embodiments, the distribution passage inlets 36 may be arrayed in, for example, an orthogonal grid pattern or other arrangement. Further, while five distribution passage inlets 36 are coupled to each flow outlet 22 in the present embodiment, in other embodiments different numbers of distribution passage inlets 36 may be utilized. Additionally, in some embodiments, the number of distribution passage inlets 36 coupled to the flow outlets 22 may be unequal, depending on, for example, flow requirements and locations of the distribution passage inlets 36 at the inlet surface 38. Further, the shape and/or size or orientation of the distribution passage inlets 36 may be varied to achieve the desired flow characteristics.

Referring now to FIGS. 4-10, shown are exemplary cross-sectional views of the flow distributor 18 taken at each flow outlet 22 of the embodiment of FIG. 3. Each cross-sectional view illustrates a plenum 40 to connect the flow distribution passages 34 to the associated flow outlet 22. The plenums 40 are configured to envelop the flow distribution passages 34 connected to the associated flow outlet 22, with the plenum 40 acting as a flow distribution passage outlet.

In one embodiment, the flow distributor 18 is formed from a plurality of stacked layers 52, each layer 52 including a plenum 40 and a flow outlet 22. The layers 52 may be joined by welding or brazing or the like to form the flow distributor 18. In other embodiments. The flow distributor may be formed by one or more additive manufacturing processes.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A fluid distributor for a two-phase fluid flow system, comprising:
a distributor housing;
a distributor inlet at the distributor housing to admit a two-phase fluid flow to the fluid distributor;
a nozzle section through which the two-phase fluid flow is directed;
a plurality of flow distribution passages located downstream of the nozzle section; and
a plurality of passage outlets in the distributor housing, each passage outlet of the plurality of passage outlets coupled to one or more flow distribution passages, the plurality of flow distribution passages configured and arrayed such that the two-phase flow through the plurality of passage outlets is uniform.

2. The fluid distributor of claim 1, further comprising a passage inlet surface located downstream of the nozzle section, each flow distribution passage having a passage inlet at the passage inlet surface.

3. The fluid distributor of claim 2 wherein a plurality of passage inlets are dispersed across the passage inlet surface.

4. The fluid distributor of claim 1, further comprising a plurality of plenums in the housing, each plenum coupled to a passage outlet and at least one flow distribution passage.

5. The fluid distributor of claim 4, wherein two or more flow distribution passages are coupled to the same plenum of the plurality of plenums.

6. The fluid distributor of claim 1, wherein each flow distribution passage is coupled to only one passage outlet of the plurality of passage outlets.

7. The fluid distributor of claim 1, wherein the nozzle section includes a converging portion, a throat portion downstream of the converging portion and a diverging portion downstream of the throat portion.

8. The fluid distributor of claim 1, wherein the fluid distributor is formed via one or more additive manufacturing processes.

9. A two-phase fluid flow heat exchanger, comprising:
a plurality of heat exchange passages; and
a fluid distributor operably connected to the plurality of heat exchange passages, including:
a distributor housing;
a distributor inlet at the distributor housing to admit a two-phase fluid flow to the fluid distributor;
a nozzle section through which the two-phase fluid flow is directed;
a plurality of flow distribution passages located downstream of the nozzle section; and
a plurality of passage outlets in the distributor housing, each passage outlet of the plurality of passage outlets coupled to one or more flow distribution passages and to a heat exchange passage of the plurality of heat exchange passages, the plurality of flow distribution passages configured and arrayed such that the two-phase flow through the each of the heat exchange passages is uniform.

10. The heat exchanger of claim 9, further comprising a passage inlet surface located downstream of the nozzle section, each flow distribution passage having a passage inlet at the passage inlet surface.

11. The heat exchanger of claim 10, wherein a plurality of passage inlets are dispersed across the passage inlet surface.

12. The heat exchanger of claim 9, further comprising a plurality of plenums in the housing, each plenum coupled to a passage outlet and at least one flow distribution passage.

13. The heat exchanger of claim 12, wherein two or more flow distribution passages are coupled to the same plenum of the plurality of plenums.

14. The heat exchanger of claim 9, wherein each flow distribution passage is coupled to only one passage outlet of the plurality of passage outlets.

15. The heat exchanger of claim 9, wherein the nozzle section includes a converging portion, a throat portion downstream of the converging portion and a diverging portion downstream of the throat portion.
